(19) United States
(12) Patent Application Publication
(10) Pub. No.: US 2011/0076663 A1
(43) Pub. Date: Mar. 31, 2011

(54) SYSTEMS AND METHODS FOR SELECTING SURVEY QUESTIONS AND AVAILABLE RESPONSES

(75) Inventors: Charles William Krallman, Beef Island (VG); Kenneth Eugene Shaw, Port St. Lucie, FL (US)

(73) Assignee: Retail Optimization International

(21) Appl. No.: 12/768,847

(22) Filed: Apr. 28, 2010

Related U.S. Application Data
(62) Division of application No. 10/643,645, filed on Aug. 18, 2003, now abandoned.

(51) Int. Cl. G09B 7/00

(52) U.S. Cl. 434/362

(57) ABSTRACT

Systems and methods are provided for selecting survey questions and response for inclusion in a survey using a survey software application. Survey questions may be selected based on the response variance or inclusion value of each survey question. A non-inclusive list of survey responses may be selected based on the selection rate of each survey response. The response rates may be adjusted to correct for instances where survey participants selected a response indicating that none of the provided responses was adequate because a hidden response was not provided. Selected survey questions and responses may be provided to a survey participant.

### BACKGROUND OF THE INVENTION

The present invention relates to systems and methods for selecting survey questions and available responses to provide to survey participants. More particularly, the present invention relates to systems and methods for incorporating multiple survey questions that cover various categories and lists of available responses into easily readable, brief questionnaires.

Surveys are typically conducted by an organization in person, over the phone, or via the World Wide Web. There may be various reasons for organizations, such as retail companies, to administer surveys. For example, surveys are a personable and effective way for receiving accurate feedback from existing customers in order to provide these customers with more commercial opportunities, better service, etc. Surveys may also provide an organization with insight as to the behavior of survey participants and the goods and services they consume. Surveys may also provide detailed demographic or ideological makeup of a group of people.

In a physical store, on a telephone, or via the World Wide Web, it is impractical to require a survey participant to partake in a survey that lasts more than a few minutes. However, in order to make accurate assessments about a large number of categories projected over a large number of individuals, it is preferable for an organization to administer long and highly detailed surveys. Indeed, there exists a significant trade-off between the burden an organization may want to impose on a surveyed individual and the quality and quantity of information that the individual may be able to provide in a shorter period of time. Generally, this means that surveys must be limited in the number of questions and issues that can be addressed.

It would therefore be desirable to allow organizations to administer surveys that are able to efficiently collect survey responses to a large number of questions by selectively providing relatively few survey questions to a large number of individuals.

It would also be desirable to selectively draw the survey questions asked from a much larger list of stored survey questions to optimize the information obtained from each surveyed individual in the shortest amount of time.

It would also be desirable to accommodate survey questions with very long response lists, while keeping the presentation of individual survey questions relatively short.

In some cases, a survey question may be provided that does not have an appropriate response that a survey participant would be willing to select. In such cases, a “None of these” response option may provide the survey participant with an opportunity to indicate that none of the responses provided are adequate for responding to the question. In some cases the survey responses provided to the survey participant may be a non-inclusive list of many stored available survey responses (e.g., when at least one available survey response to a survey question is hidden from the survey participant). In such cases, the survey participant may have selected one of the hidden survey responses instead of the “None of these” option had that hidden response actually been available to the participant. Systems and methods are publicly known that estimate how “None of these” responses may have been redistributed among the hidden survey responses based on the previous selection rate of each response. However, these systems and methods do not account for the probability that a survey participant would have still selected the “None of these” response even if all other available responses were provided.

It is therefore desirable to more accurately estimate the rate at which survey responses are selected.

### SUMMARY OF THE INVENTION

It is therefore an object of the present invention to provide systems and methods for allowing organizations to administer surveys that are able to efficiently collect survey responses to a large number of questions by selectively providing relatively few survey questions to a large number of individuals.

It is also an object of the present invention to provide systems and methods for selectively drawing the survey questions asked from a larger survey question database to optimize the information obtained from each surveyed individual in the shortest amount of time.

It is also an object of the present invention to provide systems and methods for accommodating survey questions with very long response lists, while keeping the presentation of individual survey questions relatively short.

It is also an object of the present invention to provide systems and methods for estimating the rate at which survey responses are selected.

These and other objects of the present invention are accomplished by implementing systems and methods that are able to incorporate multiple questions and available responses into easily readable, brief survey questionnaires. A variety of survey questions, spanning various categories or types of questions may be stored in a storage device. Surveys having at least one of the stored questions may be provided to users of a survey software application (e.g., survey participants). The survey application may be implemented on any suitable computing device, which may be directly accessed by the survey participant or administered via a telephone interview or other means. The questions provided in each survey may vary across different survey participants to more efficiently utilize each individual participant's time.

The survey application may select survey questions to be included in a survey based upon an inclusion value. The inclusion value for each question may be initially programmed into the survey application or an initial value may be associated with a data record for each question as it is stored. Inclusion values for each survey question may be updated in real-time and may be determined based on, for example, conditional branching logic programmed into the system, the response variance of a survey question, a global inclusion value multiplier, any suitable criteria for determining the inclusion value, or a combination thereof. Survey questions with higher inclusion values may be selected by the survey application for inclusion in a survey more frequently than survey questions with lower inclusion values. In some arrangements, a threshold inclusion value may be designated by the survey application. Survey questions having survey inclusion values higher than the designated threshold inclusion value may be selected for inclusion in the survey. Survey questions having inclusion values lower than the designated threshold inclusion value may be excluded from the survey.

The systems and methods of the present invention may also determine the rate at which survey responses have been selected. Frequently selected responses may be presented less often in subsequent surveys, thereby increasing the sample size on the remaining responses. A survey response's selection rate indicates the percent of the time that each survey response is selected and may be calculated based on the number of times a response is selected divided by the number of times it was presented. Questions with long lists of responses may, therefore, be presented to a survey participant in a brief and manageable format by reducing the number of responses provided based on the response selection rate.

Moreover, because the presentation of each question in a survey may include only a limited number of responses to choose from, it may be desirable for each response list to include a “fallback” response, for example “None of the above,” “None of these,” or any other suitable response that allows a survey participant to indicate that none of the responses provided were adequate for responding to the survey question presented. The fallback responses may be categorized as “Real” or “Reallocated” selections. Real selections are survey response selections that would have remained the same even if all available responses were presented to a survey participant. Reallocated selections are survey response selections that may have been different had survey responses not provided in a non-inclusive list of responses been presented to the survey participant. Reallocated selections may be distributed among other response selections according to the distribution of the survey response selection rate and the probability that a survey participant would have selected a hidden response had it been provided. This probability may be estimated in a number of ways. For example, reallocated selections (e.g., adders) for each response may be determined based on the selection rate of each response and the probability that a survey participant's response would have been different had hidden survey response selections been provided. The adders may be used to reallocate “None of these” selections.

### BRIEF DESCRIPTION OF THE DRAWINGS

The above and other objects and advantages of the invention will be more apparent upon consideration of the following detailed description, taken in conjunction with the accompanying drawings, in which like reference numerals refer to like parts throughout, and in which:

FIG. 1 is a diagram of illustrative software and hardware used in accordance with the present invention;

FIGS. 2 and 3 show illustrative tables for storing survey questions, survey responses, and survey response information in accordance with the present invention;

FIGS. 4 and 5 show illustrative display screens for providing survey participants with selected survey questions and selected survey responses in accordance with the present invention;

FIGS. 6 and 7 are illustrative output displays that show calculations based on stored survey response information in accordance with the present invention;

FIG. 8 is a flow chart of illustrative steps involved in selecting survey questions to be provided in accordance with the present invention; and

FIG. 9 is a flow chart of illustrative steps involved in selecting survey responses to be provided in accordance with the present invention.

### DETAILED DESCRIPTION

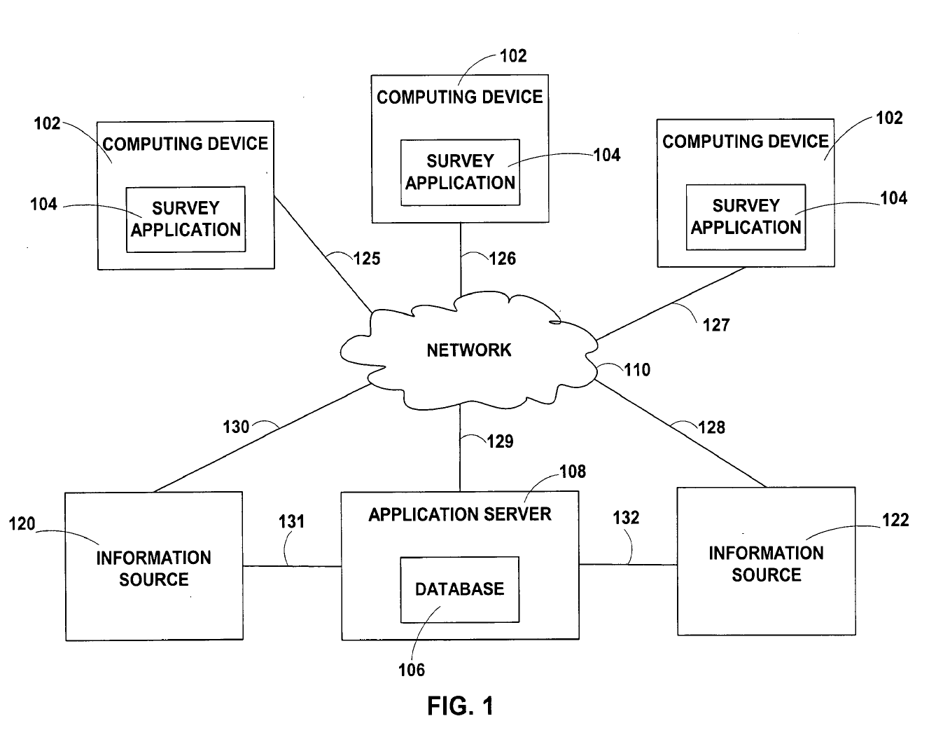

The present invention is now described in more detail in conjunction with FIGS. 1-9. Although the present invention may be illustrated as being implemented in a retail environment for assisting in the administration of retail survey questionnaires, it will be understood that the present invention may be implemented in other types of environments. For example, the present invention may be particularly useful in assisting with the administration of surveys related to politics, entertainment, education, or any other suitable topic.

FIG. 1 is a schematic diagram of illustrative software and hardware 100 that may be used to implement the systems and methods of the present invention. In FIG. 1, a survey participant may operate computing device 102. Computing device 102 may be, for example, a personal computing device (e.g., an IBM-compatible personal computer, an apple computer, etc.), a handheld computing device (e.g., a personal digital assistant), a wireless computing device, a telephone, an interactive voice response system, a point-of-sale terminal, a kiosk, or any other suitable computing device or combination of devices. There may be many instances of computing device 102 at one or more geographic locations. However, for the purposes of brevity and clarity, only several instances of computing device 102 are shown in FIG. 1.

Computing device 102 may include appropriate hardware (e.g., circuits, processors, memory, user input devices, display devices, etc.) needed for implementing algorithms or software applications, for example survey application 104 or any other suitable algorithm or software application (e.g., an operating system, a web browser, a point-of-sale transaction application, etc.).

Computing device 102 may be coupled to a storage device, such as application server 108 or any other suitable storage device. Database 106 may be implemented on application server 108 or on any other suitable device. Database 106 may be, for example, any number of multi-tiered databases for storing survey questions, survey response, survey response information provided by survey participants, or any other suitable information. In some embodiments, not shown, database 106 may be implemented as part of computing device 102, or part or all of database 106 may be implemented to both computing device 102 and application server 108.

In FIG. 1, survey application 104 is implemented on computing device 102 while database 106 is implemented on application server 108. It will be understood, however, that the software application(s) used in connection with the present invention may be implemented by any device included as part of hardware and software 100 and that the single embodiment of FIG. 1 is used merely as an illustration. For example, in one embodiment, such as the case of a perfectly distributed network (e.g., a thin-client computing arrangement, an application service provider arrangement, etc.), as is typical in a retail environment having point-of-sale terminals, all software applications may be implemented by application server 108, or any other suitable device (e.g., a mainframe computer, a supercomputer, etc.), while personal computing device 102 may only include a user interface (e.g., a user input device, a display screen, etc.).

The information in database 106 may include survey questions, responses, and survey response information. The information in database 106 may be in any suitable data management format, environment, or application. For example, a relational database format, an object oriented database format, a data warehouse, a data directory, a knowledge management system, or any other suitable format, environment or application may be used for storing and indexing related information. The hardware (e.g., application server 108, computing devices 102, etc.) and software (e.g., database 106, survey application 104, etc.) may use various other hardware and software for making the calculations described herein.

Database 106 may reside locally (e.g., as part of or adjacent to computing device 102), or at a location remote from computing device 102 and accessed via network 110. Computing device 102 may be coupled to network 110 via communications paths 125-127. Network 110 may be a local or wide area network (e.g., the Internet, an intranet, a virtual private network, etc.) and may support any combination of wired, wireless, or optical communications. Application server 108 may be coupled to network 110 via communications path 129.

The hardware and software configuration of FIG. 1 may also include information sources 120 and 122, which may be a web server, a database, or any other suitable device for storing information such as an organization's financial information, transaction information derived from point-of-sale information, survey participant profile information, survey response information, national economic and industry information, or any other suitable information. Information sources 120 and 122 may be coupled to network 110 via communications paths 128 and 130. In addition or alternatively, information sources 120 and 122 may be coupled directly to application server 108 via communications paths 131 and 132. In either embodiment, the information stored in information sources 120 and 122 may be accessed by application server 108 or computing device 102.

Communications paths 125-132 may be any suitable wired or wireless communications path. For example, if wire-based, communications paths 125-132 may be serial connections, parallel connections, telephone cables, copper wire, electric cable, fiber optic cable, coaxial cable, Ethernet cable, USB cable, FireWire cable, component video cables, composite cables, any other suitable wire-based communications path, or any combination thereof. If wireless, any suitable communications protocol or standard such as IEEE 802.11, wireless application protocol (WAP), radio frequency (RF), Bluetooth, (Extended) time division multiple access (TDMA), code-division multiple access (CDMA), global systems for mobile communications (GSM), or any other suitable wireless communications path or protocol may be used. A combination of wired and wireless communication paths may also be used. Communications paths 125-132 may provide access to network 110 via a web server, a network gateway, any other suitable device, or a combination thereof.

The software and hardware illustrated in FIG. 1 may be used to implement the systems and methods of the present invention. For example, a survey participant may operate computing device 102 to access survey application 104. Survey application 104 may include any software application that provides survey participants with survey questions and available responses. Survey application 104 may use information in database 106 to create surveys for survey participants. For example, survey application 104 may use data stored in database 106 to create display screens of survey questions and responses.

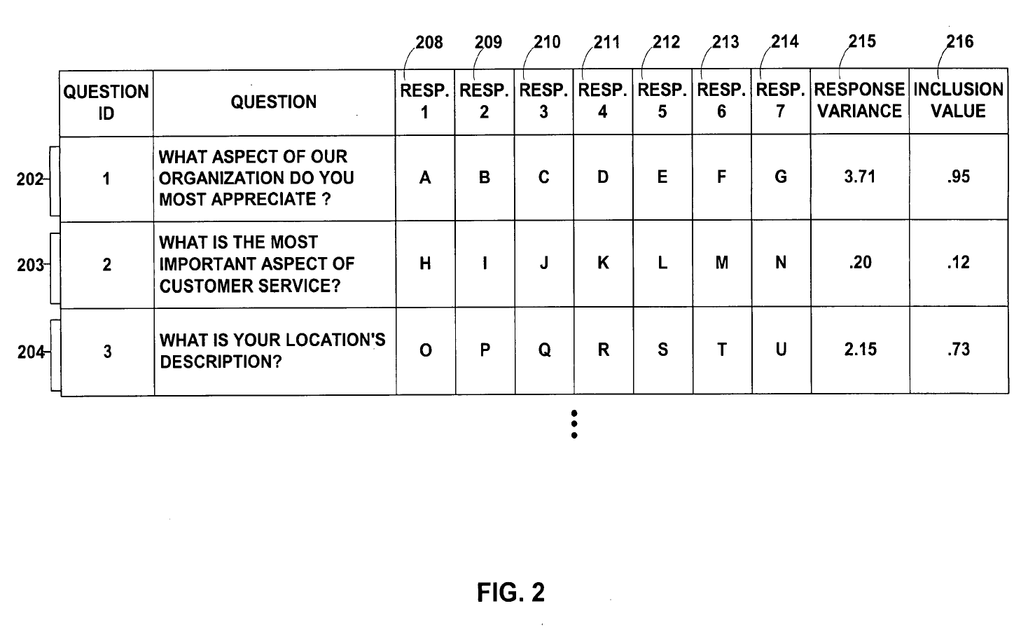

The data used by survey application 104 to generate surveys may be stored in any suitable format. FIG. 2 shows an illustrative example of how survey questions may be stored in database 106. FIG. 2 includes survey questions 202-204, which may include responses 208-214. It will be understood that it is preferable for many survey questions to be stored. However, for the purposes of brevity and clarity, only several instances of stored survey questions are depicted in FIG. 2. The variance 215 and inclusion value 216 for each survey question may also be included for each survey question stored.

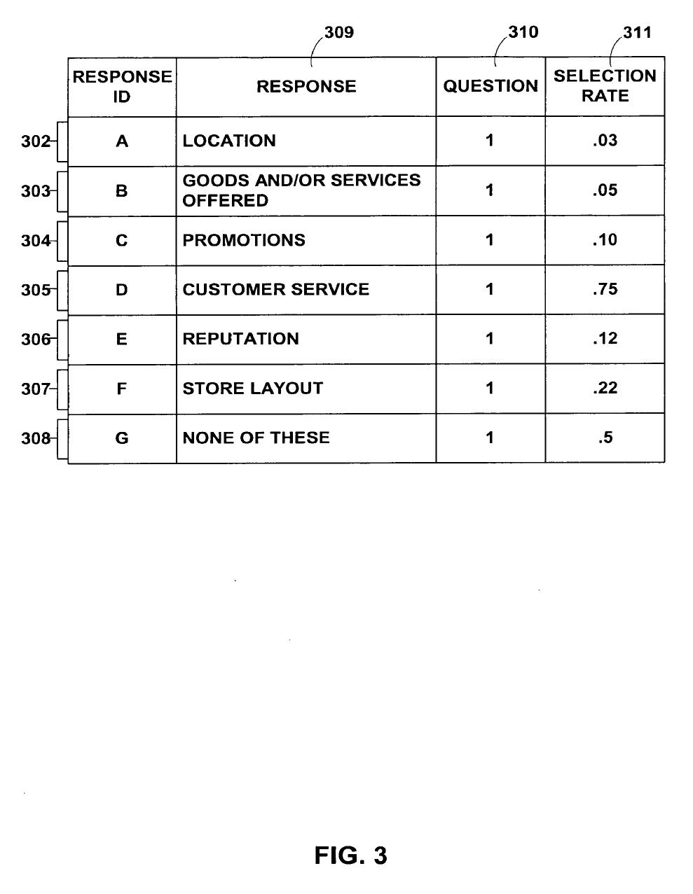

FIG. 3 shows an illustrative example of how survey responses may be stored in database 106. FIG. 3 includes a list of survey responses 302-308 that correspond to an identified survey question 310. The response text 309 may also be provided. In the example provided in FIG. 3, the identified survey question 310 (e.g., survey question 1) corresponds to survey question 202 of FIG. 2 and the survey responses 302-308 (e.g., survey responses A-G) correspond to those indicated in FIG. 2. The selection rate 311 of each stored survey response may also be provided.

Survey application 104 may create surveys by selecting at least one survey question from a list of survey questions 202-204 stored in database 106. Survey application 104 may provide a list of survey responses 208-214 for each survey question provided. The survey responses provided by survey application 104 may be selected from a list of survey responses (e.g., survey responses 302-308 of FIG. 3) stored in database 106 that correspond to each survey question.

Survey questions and responses may be selected by survey application 104 in real-time according to a specific criteria, and the survey questions may be provided to at least one survey participant. The networked arrangement of computing devices 102, survey application 104, and database 106 shown in FIG. 1 allows survey application 104 to determine whether a survey question meets a given criteria and then to provide the selected survey question in real-time. While collecting survey response information from a survey participant, a real-time determination of a survey question's response variance may be determined. The response variance may be updated when a survey participant submits a response for a single survey question or at the end of a survey consisting of multiple survey questions. The survey question responses selected by survey participants (e.g., survey response information) may be transmitted to, and stored by, database 106 or any other suitable storage device (e.g., information sources 120 and 122, etc.). The storage device used to store survey response information may include hardware and software for calculating the response variance for each survey question for which responses have been provided by survey participants. A survey question's response variance may be calculated using known methods for calculating the variance (e.g., by determining the square of the standard deviation of responses to a particular survey question).

For each survey question stored in database 106, there may be a data item corresponding to the response variance for that survey question (e.g., variance field 215 of FIG. 2). Survey application 104 may utilize this data item when determining which survey questions to provide to a survey participant. For example, survey application 104 may select survey questions having a higher response variance over survey questions having a lower response variance in order to shorten the survey's duration and to include only those questions for which larger sample sizes are needed. Survey questions that have low variance may have a common response selected by the vast majority of survey participants and such questions may, therefore, require little further sampling. Accordingly, it may not be necessary to include such questions in surveys as frequently as those questions with a higher response variance. This method of selecting survey questions reduces the number of survey questions that a survey participant must respond to and, therefore, reduces the amount of time needed to administer a survey.

A designated variance level may be initially determined (e.g., by survey application 104) so that all questions are presented with some minimal frequency, regardless of the response variance of any given question. In a survey presented over a long period of time, the variance analysis may be divided into time segments and the variance for a more recent time period may be calculated independently from prior time periods. Therefore, changes in population or public sentiment may quickly be detected from survey participants' responses. For example, survey application 104 may designate a particular time period and use survey response information (which may include a time stamp) to calculate the response variance for the designated time period.

In another suitable approach, survey application 104 may select survey questions to be included in a survey based upon inclusion values. The inclusion value for each question may be initially programmed into the survey application or an initial inclusion value may be associated with a data record for each question as it is stored. Inclusion values for each survey question may be updated in real-time and may be determined based on, for example, conditional branching logic programmed into the system, the response variance of a survey question, a global inclusion value multiplier, any suitable criteria for determining the inclusion value, or a combination thereof. Survey questions having higher inclusion values may be selected by survey application 104 for inclusion in a survey more frequently than survey questions having lower inclusions values. In some arrangements, a threshold inclusion value may be designated by the survey application. Survey questions having survey inclusion values higher than the designated threshold inclusion value may be selected for inclusions in the survey. Survey questions having inclusion values lower than the designated threshold inclusion value may be excluded from the survey.

There are several approaches for determining the inclusion value of a survey question. In one suitable approach, predefined conditional branching logic, which may logically relate survey questions to one another based on a survey participant's response, may be used to determine the inclusion value of subsequent survey questions once the survey participant has provided a response to a survey question. For example, one survey participant may be provided with a string of survey questions that are different from those provided to another survey participant because the survey participant's responses were different for at least one of the questions provided. The predetermined conditional branching logic may be associated with the stored survey questions or may be based on logic programmed into survey application 104.

In another suitable approach, each survey question's response variance may be used to determine the inclusion value of each survey question. For example, fluctuations in a given question's response variance may be detected if survey participants' responses are notably inconsistent with responses previously provided by other survey participants. A desired variance may have been predefined and previously programmed into survey application 104 and a real-time variance estimate may be compared to the desired variance. If the variance is found to be above the desired variance, the inclusion value may be increased for that question and, thus, survey application 104 may select that question more often to increase the survey question's sample size. Conversely, if the response variance for a survey question is below the desired variance programmed into survey application 104, the inclusion value may be decreased for that question and survey application 104 may select that survey question less frequently.

A survey question's inclusion value may be related to an initial inclusion value (e.g., designated by survey application 104 prior to providing any survey questions), the survey question's variance, and a desired variance. For example:

$$I = {I}_{Base} * \frac{{V}_{Current}}{{V}_{des}}$$

Where:
I_{Base}=Inclusion value
I_{Base}=Initial inclusion value
V_{Current}=Current variance
V_{des}=Desired Variance

Another suitable approach for determining a question's inclusion value may include monitoring survey duration and increasing or decreasing a global inclusion value multiplier for the questions that have not yet been presented. For example, if the survey is taking a long time for a survey participant to complete, the global inclusion value multiplier may be decreased in order to reduce the probability of inclusion of the remaining survey questions. Conversely, if a survey is being completed more rapidly, the global inclusion value multiplier may be increased for each remaining survey question. If questions are being selected based on whether their inclusion value is higher or lower than a value designated by survey application 104, globally increasing or decreasing the inclusion values of the remaining questions will increase or decrease the number of survey questions provided.

The inclusion value may be updated at the individual and global level, such that an individual survey may increase or decrease the inclusion value for a given question to meet a specified time goal. Subsequent surveys may implement global increases or decreases in inclusion value to average the survey time calculated over several recent surveys (e.g., to arrive at an average consistent with a predefined average programmed into survey application 104). Alternatively, the survey may end after a predetermined time period.

It will be understood that the inclusion value of a given survey question may be determined using any of the foregoing techniques. For example, the inclusion value may be determined based on predefined conditional branching logic, response variance, a global inclusion value multiplier, any other suitable information, or any combination thereof. In some arrangements, it may be desirable to use a combination of these techniques to determine a survey question's inclusion value, and the various techniques may be weighted to arrive at a desired technique for selecting survey questions based on inclusion values. It is preferred, however, to apply an identical inclusion value calculation to all stored survey questions.

The foregoing description illustrates systems and methods for selecting survey questions. In another aspect of the present invention, systems and methods are provided for selecting survey responses. A survey question selected by survey application 104 may include many possible survey responses. For example, in FIG. 2, survey questions 202-204 may include survey responses 208-214 (e.g., identified as survey responses A-U). Survey responses for survey question 202 (e.g., responses A-G) may correspond to survey responses 302-308 of FIG. 3. A response's selection rate may be calculated once the survey participants' responses are stored (e.g., using the survey response information). A response's selection rate may be calculated based on the number of times a survey response was selected by survey participants divided by the number of times it is presented in a survey.

For each survey response stored in database 106, there may be a data item corresponding to the rate at which that survey option is selected by survey participants (e.g., selection rate field 311 of FIG. 3). Survey application 104 may utilize this data item when determining which responses to provide a survey participant. Survey application 104 may select responses with lower selection rates in order to increase the sample size of these survey responses (e.g., survey responses 302, 303 and 304 may have the lowest selection rate of the survey responses available for survey question 202). Reducing the number of responses presented for each question allows questions with long lists of responses to be presented to a survey participant in a brief and manageable format. Also, it may be desirable to select survey responses in this manner if the sample size for a survey response increases to the point that it is no longer desirable to sample the response (e.g., if the sample size is large enough to account for selection variance of the response). A survey response with a large sample size may be displayed less frequently, allowing other survey responses to be presented with higher frequency.

It will be understood that a survey response's selection rate may be determined using the aforementioned method regardless of whether a given survey question allows for more than one survey response to be selected by a survey participant.

Survey questions and responses may be presented to a survey participant using, for example, survey application 104 and the associated software and hardware of FIG. 1. Survey application 104 may present a series of interactive display screens that may ask survey participants to respond to questions and input information. Survey application 104 may be implemented in conjunction with a standard web browser application (e.g., Microsoft's Internet Explorer, Netscape Navigator, etc.) and accessed over the Internet. Alternatively, the survey application may be implemented in conjunction with a proprietary or commercially available software application interface and accessed over a public or private network (e.g., in an arrangement using a point-of-sale terminal) or a proprietary or commercially available software application interface accessed locally (e.g., in an arrangement using an exit kiosk as computing device 102). Any other suitable arrangement or implementation may also be used. User input devices, such as a mouse, keyboard, telephone keypad, touch-sensitive display screen, or any other suitable user input device, may also be used to allow survey participants to interact with survey application 104 and may be included as part of computing device 102. Display devices such as a computer monitor, a handheld display, or any other suitable device, may be used to present display screens of survey questions to the survey participant.

It will be understood that some arrangements of the present invention, for example in an arrangement using a telephone system to implement survey application 104, display screens may not be needed and the selected survey questions and responses may be provided audibly over a telephone. In such an arrangement, survey participants may indicate responses using a telephone keypad and the survey response information may be transmitted to and stored by the storage device, and used to select survey questions and responses, in the same manner set forth in the forgoing description.

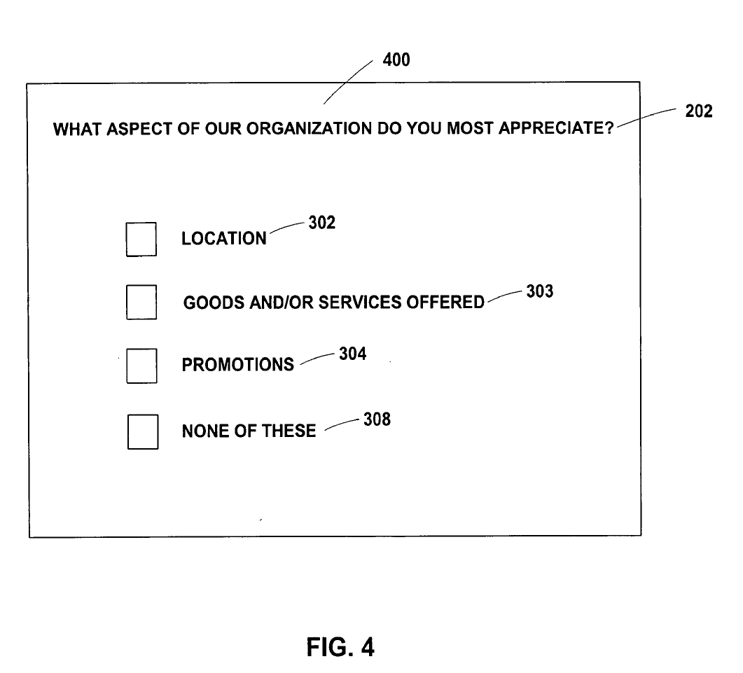

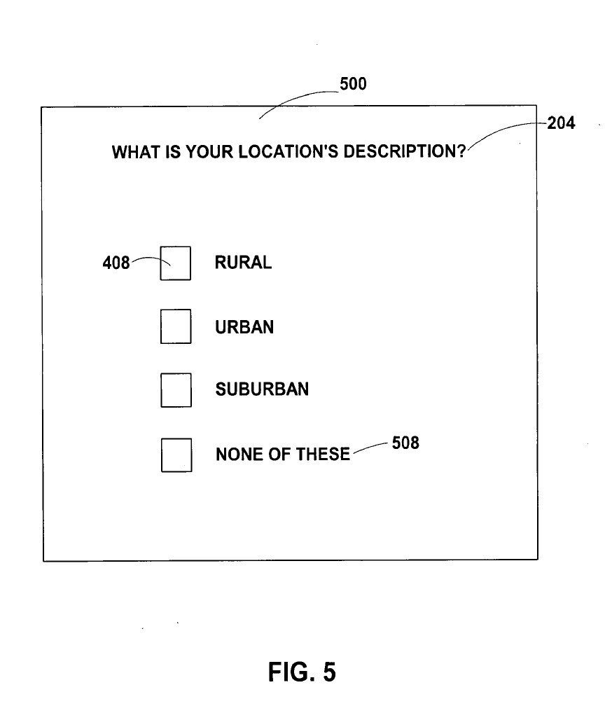

Illustrative display screens of survey questions and responses that may be displayed by survey application 104 in an arrangement using, for example, a personal computer or kiosk, are set forth in FIGS. 4 and 5. FIG. 4 shows display screen 400 that may include survey question 202. Survey question 202 may be selected from among many survey questions stored in a storage device (e.g., application server 108 of FIG. 1). Survey application 104 may have selected survey question 202 over other available survey questions (e.g., survey questions 203 and 204) to be presented in display screen 400. For example, FIG. 2 shows that survey question 202 has the highest variance 215. Survey application 104 may therefore determine that responses to survey question 202 vary more than the responses to other available survey questions. Alternatively, survey application 104 may have selected question 202 because the question's inclusion value 215 (FIG. 2) is higher than the other available survey questions (e.g. survey questions 203 and 204).

Responses to survey question 202 may also be included as part of display screen 400, for example, survey responses 302, 303, 304, and 308. For each survey response provided, there may be an area 408 to be used by a survey participant to indicate a response. The responses provided in display screen 400 may not be a complete list of the survey responses available for survey question 202. For example, as shown in FIGS. 2 and 3, survey question 202 may have several possible survey responses 208-214 (which correspond to responses 302-308 of FIG. 3). However, to provide survey responses in a brief and manageable format, only several survey responses are provided on display screen 400. Once the survey participant has indicated a response to the survey question, the survey response information may be transmitted to and stored by a storage device (e.g., application server 108 of FIG. 1 or any other suitable device). Survey response information may also be stored locally on computing device 102 or any other suitable local storage device.

FIG. 5 shows display screen 500 which may include another survey question, such as survey question 204. Survey application 104 may select survey question 204 based on the question's inclusion value (e.g., as shown in inclusion value field 216 of FIG. 2). The inclusion value for survey question 204 may have been increased in real-time once the survey participant selected “Location” survey response 302 in response to survey question 202 (provided in FIG. 4). The increase in the inclusion value of question 204 may have been caused by conditional branching logic associated with that response programmed to automatically increase the inclusion value for survey question 204 if response 302 was selected for question 204 (e.g., because survey response 302 and survey question 204 both relate to location).

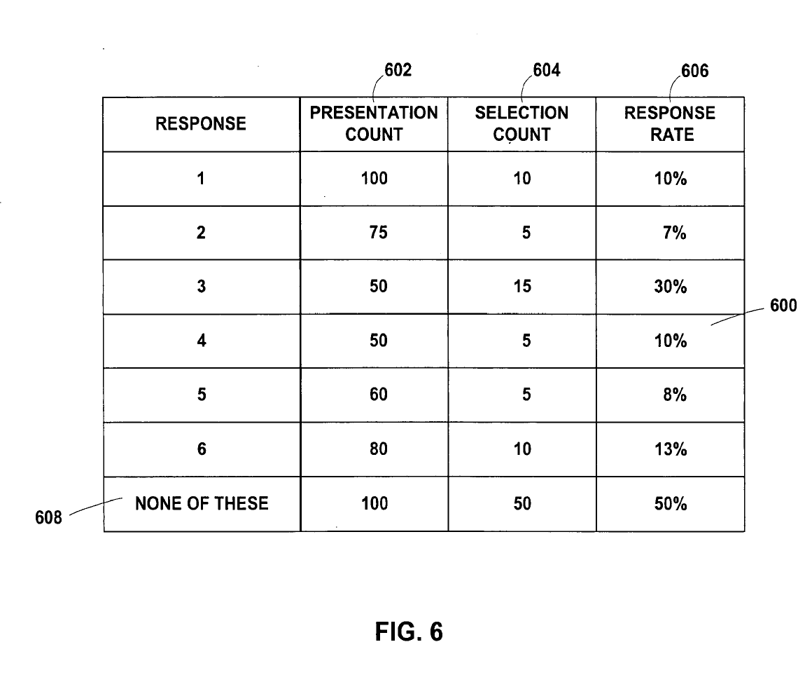

Each survey question selected by survey application 104 may include a “None of these” survey response, such as survey responses 308 (FIG. 4) and 508 (FIG. 5), or any similar response that allows survey participants to indicate that none of the survey responses provided offers an adequate response to the survey question provided. The responses submitted by survey participants (e.g., survey response information) may be stored in a storage device, such as application server 108 or any other suitable device. The stored survey response information for each survey question may be displayed in a table such as table 600 of FIG. 6. The presentation count 602, selection count 604, and selection rate 606 for each available survey response may be indicated. The presentation count 602, selection count 604, and selection rate 606 may also be provided for “None of these” response 608.

In FIG. 6, the “None of these” response was presented 100 times and selected 50 times. Because this response may be displayed every time a survey question is presented, it may be determined that the given survey question was presented 100 times. It may also be determined, therefore, that the “None of these” response was selected half the times the question was presented. The average number of survey responses presented for each survey question may also be calculated, for example by totaling the number of times all responses were presented and dividing by the number of times the survey question was provided.

It may be desirable to determine the probability that a survey participant's “None of these” results would have been different had the entire list or survey questions been provided. The average number of survey responses provided for a given survey question (“X”) may determine the amount of space needed to present the survey question and list of responses. For example, a wordy survey question may have room only for three responses on a single display screen (and therefore present an average of 3 responses each time the survey question is provided). Or, the survey question may be relatively short, leaving more room for responses (e.g., if the average number of responses provided was 5). The total number of available responses to a given survey question (“Y”) may also be identified (see for example, FIGS. 2 and 3). The number of “None of these” responses that were made only because the appropriate response was hidden when the survey question was presented (e.g., the survey participant would have selected a hidden response) may be estimated as follows:
Where:

Hidden=1−(X/Y)
Hidden=Percentage of responses hidden on average screen
Where:

Reallocated=Sample*Hidden
Reallocated=Number of “None of these” responses that would have been different if the entire list or survey responses was provided
Sample=Number of times the question was presented
Where:

Real=Selected−Reallocated
Selected=Number of time the “None of these” response was selected
Real=Number of “None of these” responses which should remain such

In the illustrative example, the average number of survey responses provided for the given survey question (“X”) is 4 and the total number of available responses (“Y”) is 7. Therefore, the rate at which the “None of these” responses were selected only because more appropriate responses (e.g., hidden responses) were not provided may be estimated as 1−4/7, or 0.429 (e.g., it may be estimated that 43 percent of the time that survey participants selected the “None of these” response when presented with a non-inclusive list of available responses, a more suitable response would have been selected if all available responses had been provided). Because the survey question was provided 100 times, the Reallocated value may be computed as 100×0.43, or 43. It may be determined, therefore, that 43 of the 50 “None of these” selection should be reallocated to the remaining responses (e.g., based on the selection rate of each response). Accordingly, 7 of the original 50 “None of these” selections should remain such.

The raw percent of responses for all responses except the “None of these” response may also be totaled (in the above example, 78 percent). The Reallocated value may be distributed among other responses according to the frequency distribution of the raw percentages. The adjustments (e.g., redistribution) to the other responses will be referred to as “adders.” Adders for each response may be determined based on the selection rate of each response and the probability that a survey participant's response would have been different had other survey response selections been available. The adders may be used to reallocate “None of these” selections. For example:

$$An = \frac{SR}{T} * R$$

Where:
An=Adder for a given response
SR=Selection rate for the given response
T=Total selection rate for all responses other than “None of these” response
R=Number of “None of these” responses to be reallocated

Accordingly, for response 1 of FIG. 6:

$$A 1 = \frac{10}{78} * 43$$

Where:
A1=Number of selection counts to be added to response 1

For response 2 of FIG. 6:

$$A 2 = \frac{7}{78} * 43$$

Where:
A2=Number of selection counts to be added to response 2

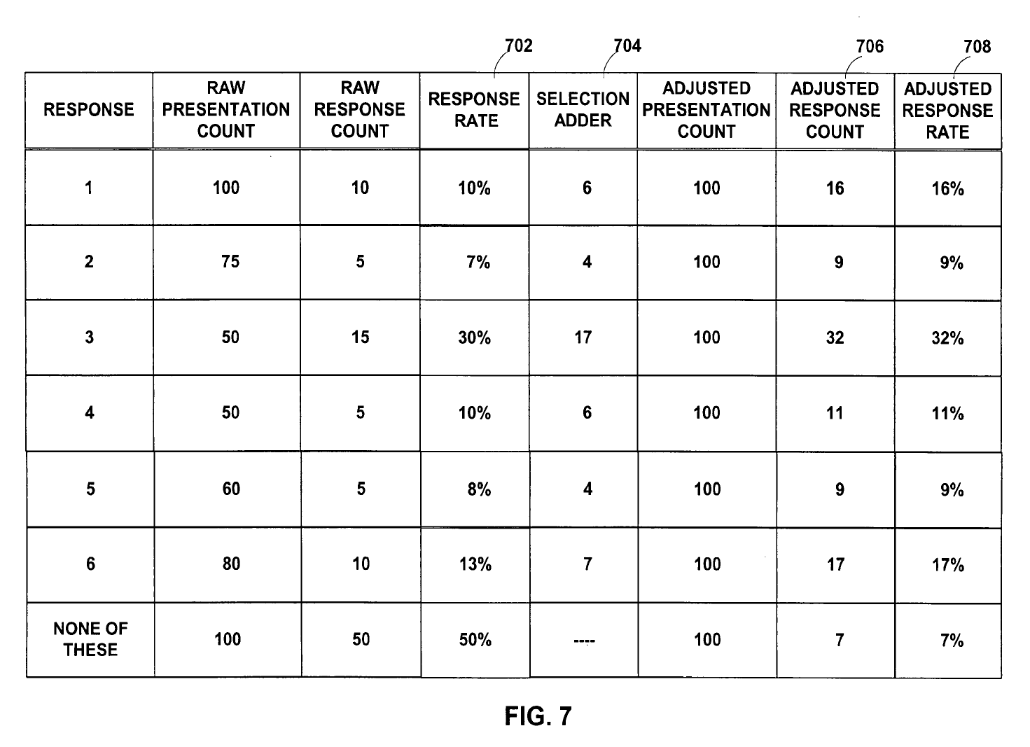

Each of these “Adders” (e.g., A1, A2, etc.) may be added to the observed selection rate for each survey response to determine a more accurate estimation of the true selection rates for a survey question had all available responses for the selected question been provided (e.g., if no survey responses were hidden). For example, FIG. 7 shows table 700 which shows how the adders are used to adjust the initial selection rate 702 to correct for “None of these” responses that should be reallocated. The adders 704 may be provided and added to the initial selection rate 702 for each survey response. An adjusted selection count 706 may be provided. Adjusted selection count 706 incorporates the “None of these” responses reallocated for each question. An adjusted selection rate 708 may then be determined for each response by calculating the percent of the time each response would have been selected if all available responses were always provided (e.g., using the number of times the survey question was presented).

In an alternative embodiment, determining the distribution of reallocated “None of these” selections may include comparing survey response selections from among various survey participants. For example, a survey participant who selected the “None of these” response to a survey question and who was not shown response option #6 from the full list of responses may be compared to all other survey participants who did see response option #6 when asked the same question. These other survey participates may be filtered to determine those survey participants that are most similar to the survey participant that did not see response option #6. The percentage of survey participants that selected response option #6 may be used to represent a probability that the survey participant who did not see option #6 would have selected it had the customer seen survey response #6. This process may be repeated for each survey response that the survey participant did not see. A probability distribution for estimating the “true” intended response among all the responses not shown to a survey participant may then be provided.

It will be understood that, when using either approach for selecting survey responses, survey responses may initially be selected by a method other than those described by the foregoing. For example, survey responses may initially be randomly selected, or any other suitable method for initially selecting survey responses may be used. This allows a suitable sample size to be collected for each response before using the foregoing systems and methods to select responses.

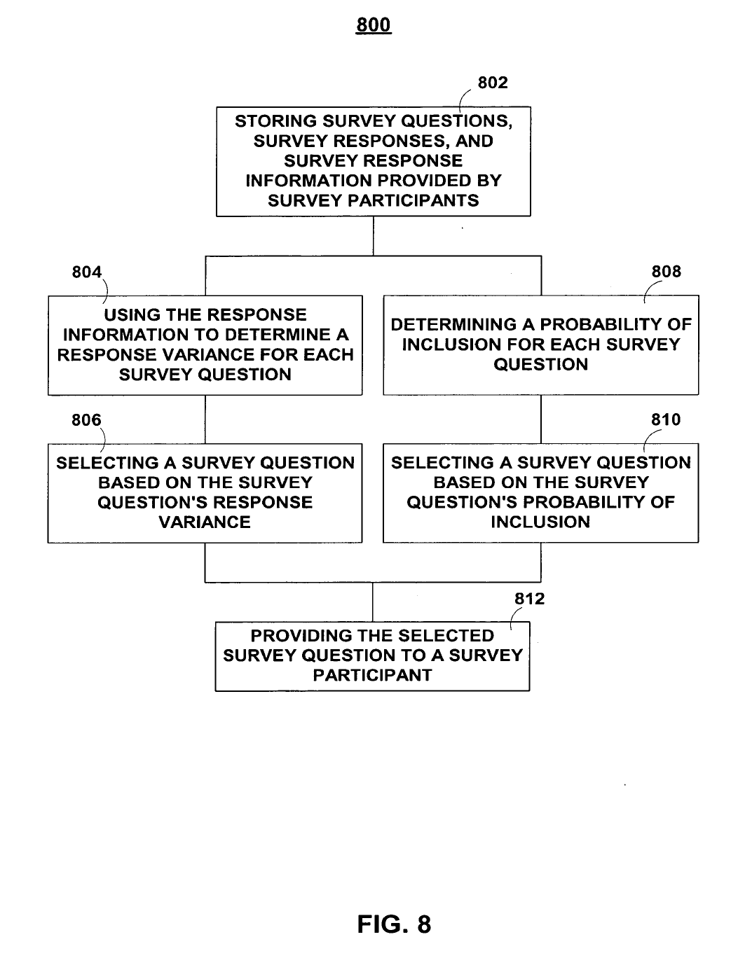

A flow chart 800 of illustrative steps that may be involved in selecting survey questions to be provided to a survey participant in accordance with the present invention is shown in FIG. 8. At step 802, survey questions, survey responses and survey response information provided by survey participants may be stored in a storage device, for example application server 108.

A survey question may be selected using the approaches set forth in steps 804 and 806 or steps 808 and 810. At step 804, the survey response information may be used to determine a response variance for each survey question. A question's response variance may be calculated, for example, using conventional mathematical techniques for determining the variance of a data set. At step 806, the response variance may be used to select a survey question. For example, survey questions having a relatively high variance may be selected for inclusion in a survey over survey questions having a relatively low variance. Or, survey questions may be selected by comparing their variance to a threshold variance, and questions having a response variance higher than the threshold variance may be selected for inclusion in the survey while survey questions having a variance lower than the threshold variance may be excluded from the survey).

Alternatively, at step 808, an inclusion value may be determined for each survey question. The inclusion value may be determined, for example, using conditional branching logic, response variance, a global inclusion value multiplier, any other suitable information, or a combination thereof. At step 810, the inclusion value may be used to select a survey question from a list of survey questions. For example, survey questions having a relatively high inclusion value may be selected for inclusion in a survey over survey questions having a relatively low inclusion value. Or, survey questions may be selected by comparing their inclusion value to a threshold inclusion value, and questions having an inclusion value higher than the threshold inclusion value may be selected for inclusion in the survey while survey questions having an inclusion value lower than the threshold inclusion value may be excluded from the survey. At step 812, the selected survey question may be provided to the survey participant.

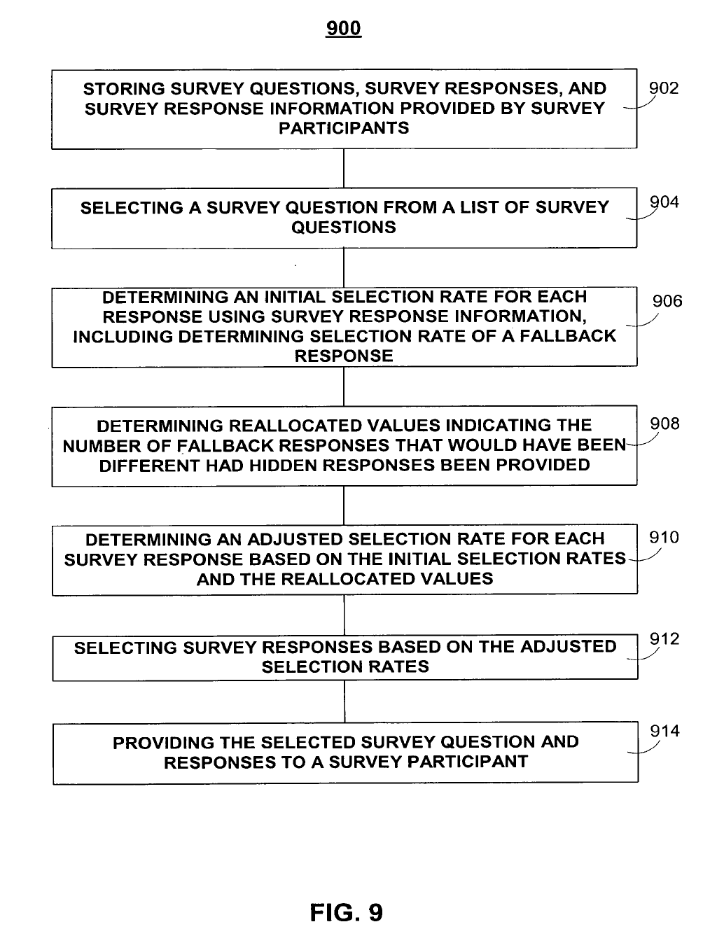

A flow chart 900 of illustrative steps that may be involved in selecting available responses to survey questions in accordance with the present invention is shown in FIG. 9. At step 902, survey questions, survey responses, and survey response information provided by survey participants may be stored in a storage device, for example application server 108. At step 904, a survey question is selected from a list of survey questions (e.g., in accordance with the foregoing systems and methods for selecting survey questions). At step 906, an initial selection rate for each survey response for the selected survey question may be determined using survey response information. A initial responses selection rate may be determined by dividing the number of times a response was previously selected by the number of times the response was previously presented in a survey. A selection rate for a fallback response may also be determined at step 906. A fallback response (e.g., “None of these”) may be used to allow a survey participant to indicate that none of the responses provided are appropriate.

At step 908, a reallocated value may be determined which may indicate the number of fallback responses that would have been different if previously hidden responses been presented to previous survey participants. The reallocated value may be, for example, the percentage of “None of these” responses that may have been different had hidden responses been provided. In another suitable approach, the reallocated value may be the actual number of “None of these” selections that may have been different had the previously hidden responses been provided (in this approach, the reallocated value represents the actual number of responses to be reallocated among the remaining responses).

At step 910, the initial selection rate for each question may be adjusted using the reallocated values determined at step 908 (e.g., redistributing the selected “None of these” responses to the remaining responses). This may be accomplished by multiplying the number of “None of these” responses to be reallocated by the initial selection rate determined in step 906 and dividing by the total selection rate of all responses other than the “None of these” response.

At step 912, survey responses are selected using the adjusted selection rate. For example, survey responses having lower adjusted selection rates may be selected over responses having higher adjusted selection rates to increase the sample size of those responses. At step 912, the selected survey question and responses are provided to a survey participant.

It will be understood that the orders of steps shown in FIGS. 8 and 9 are merely illustrative and that orders other than those shown may also be used. For example, determining initial selection rates for stored survey responses (step 906) may occur in real time and these determination may be made prior to selecting a survey question to be provided (step 904).

It will also be understood that numerous arrangements for the forgoing systems and methods may be implemented. For example, the foregoing systems and methods may be incorporated into retail point of sales terminals in a physical store so that survey questions may be provided to survey participants throughout the checkout process (e.g., via sales clerks, customer service representatives, etc.). A similar approach may be used in an online environment, for example when a user proceeds to a “checkout” process using an electronic commerce website provided over on the World Wide Web. In another suitable approach, the foregoing systems and methods may be implemented on a telephone or other interactive voice response system, and known technologies for voice synthesis and voice recognition may be used to provide survey questions and responses and to receive and store survey response information.

The foregoing is merely illustrative of the principles of this invention and various modifications may be made by those skilled in the art without departing from the scope and spirit of the invention. Those skilled in the art will appreciate that the present invention may be practiced by other than the described embodiments, which are presented for purposes of illustration and not of limitation, and the present invention is limited only by the claims.

1-18. (canceled)

19. A method for selecting responses to a survey question for inclusion in a non-inclusive list of available responses, the method comprising:
storing survey questions, survey responses, and survey response information;
selecting a survey question from a list of survey questions;
determining initial selection rates of survey responses corresponding to the selected survey question using the survey response information, wherein one survey response is a fallback response, and wherein the fallback response indicates that none of the other responses are appropriate;
determining a reallocated value of the fallback responses that would have been different had previously hidden responses been presented to previous survey participants, wherein at least one of the fallback responses is determined to have been the same had the previously hidden responses been presented to the previous survey participants;
determining an adjusted selection rate for each response based on the initial selection rate and the reallocated value;
selecting at least one survey response for the selected survey question based on the adjusted response selection rate for each response; and
providing the selected survey question and at least one response to a survey participant.

20. The method of claim 19, wherein the selected survey question and at least one survey response are provided to the survey participant via a computing device.

21. The method of claim 20, wherein the computing device is a personal computing device.

22. The method of claim 20, wherein the computing device is an exit kiosk.

23. The method of claim 20, wherein the computing device is a point-of-sale terminal.

24. The method of claim 20, wherein the computing device is an interactive voice response system.

25. The method of claim 20, wherein the survey questions and responses are stored in a location local to the computing device.

26. The method of claim 20, wherein the survey questions and responses are stored in a location remote from the computing device.

27. The method of claim 19, wherein the selection rate of each survey response is calculated by dividing the number of times the survey response was selected by the number of times the survey response was presented.

28. The method of claim 19, wherein the initial and adjusted selection rates for each survey response are determined in substantially real-time as the survey response information is stored.

29. The method of claim 19, wherein the adjusted selection rate is calculated using an adder for each survey response.

30. The method of claim 29, wherein the adder for each survey response is calculated by dividing the initial selection rate of each response by the total response rate for all responses other than the fallback response and multiplying the result by the reallocated value.

31. The method of claim 19, wherein the reallocated value is the number of fallback responses to be reallocated.

32. The method of claim 19, wherein an inclusion value is used to select the survey question.

33. The method of claim 32, wherein the inclusion value is based on conditional branching logic associated with each survey question.

34. The method of claim 32, wherein the inclusion value is based on a response variance associated with each survey question.

35. The method of claim 32, wherein the inclusion value for each survey question is a response variance.

36. The method of claim 32, wherein the inclusion value is based on a global inclusion value multiplier.

37. The method of claim 32, wherein the inclusion value is based on conditional branching logic, response variance, and a global inclusion value multiplier.

38-54. (canceled)

55. A system for selecting responses to a survey question for inclusion in a non-inclusive list of available responses, the system comprising:
at least one database for storing survey questions, survey responses, and survey response information;
a survey application for selecting a survey question and at least one response to the survey, wherein the at least one survey response is selected based on an adjusted response selection rate for each response, and wherein the adjusted response selection rate is determined using hardware and software configured to:
determine initial selection rates of survey responses corresponding to the selected survey question using the survey response information, wherein one survey response is a fallback response, and wherein the fallback response indicates that none of the other responses are appropriate;
determine a reallocated value of the fallback responses that would have been different had previously hidden responses been presented to previous survey participants, wherein at least one of the fallback responses is determined to have been the same had the previously hidden responses been presented to the previous survey participants; and
determine then adjusted selection rate for each response based on the initial selection rate and the reallocated value; and
a computing device for providing the selected survey question and at least one response to a survey participant.

56. The system of claim 55, wherein the computing device is a personal computing device.

57. The system of claim 55, wherein the computing device is an exit kiosk.

58. The system of claim 55, wherein the computing device is a point-of-sale terminal.

59. The system of claim 55, wherein the computing device is an interactive voice response system.

60. The system of claim 55, wherein the at least one database is in a location local to the computing device.

61. The system of claim 55, wherein the at least one database is in a location remote from the computing device.

62. The system of claim 55, wherein the software and hardware are configured to calculate the selection rate of each survey response by dividing the number of times the survey response was presented by the number of times the survey response was selected.

63. The system of claim 55, wherein the software and hardware are configured to determine the initial and adjusted selection rates for each survey response in substantially real-time as the survey response information is stored.

64. The system of claim 55, wherein the software and hardware are configured to calculate the adjusted selection rate using an adder for each survey response.

65. The system of claim 64, wherein the software and hardware are configured to calculate the adder for each survey response by dividing the initial selection rate of each response by the total response rate for all responses other than the fallback response and multiplying the result by the reallocated value.

66. The system of claim 55, wherein the reallocated value is the number of fallback responses to be reallocated.

67. The system of claim 55, wherein the survey application selects the survey question based on the selected survey question's response variance.

68. The system of claim 67, wherein the inclusion value is based on conditional branching logic associated with each survey question.

69. The system of claim 67, wherein the inclusion value is based on a response variance associated with each survey question.

70. The system of claim 67, wherein the inclusion value for each survey question is a response variance for each survey question.

71. The system of claim 67, wherein the inclusion value is based on a global inclusion value multiplier.

72. The system of claim 67, wherein the inclusion value is based on conditional branching logic, response variance, and a global inclusion value multiplier.

73-90. (canceled)

91. A system for selecting responses to a survey question for inclusion in a non-inclusive list of available responses, the system comprising:
means for storing survey questions, survey responses, and survey response information;
means for selecting a survey question from a list of survey questions;
means for determining initial selection rates of survey responses corresponding to the selected survey question using the survey response information, wherein one survey response is a fallback response, and wherein the fallback response indicates that none of the other responses are appropriate;
means for determining a reallocated value of the fallback responses that would have been different had previously hidden responses been presented to previous survey participants, wherein at least one of the fallback responses is determined to have been the same had the previously hidden responses been presented to the previous survey participants;
means for determining an adjusted selection rate for each response based on the initial selection rate and the reallocated value;
means for selecting at least one survey response for the selected survey question based on the adjusted response selection rate for each response; and
means for providing the selected survey question and at least one response to a survey participant.

92. The system of claim 91, wherein the selected survey question and at least one survey response are provided to the survey participant via a computing device.

93. The system of claim 92, wherein the computing device is a personal computing device.

94. The system of claim 92, wherein the computing device is an exit kiosk.

95. The system of claim 92, wherein the computing device is a point-of-sale terminal.

96. The system of claim 92, wherein the computing device is an interactive voice response system.

97. The system of claim 92, wherein the survey questions and responses are stored in a location local to the computing device.

98. The system of claim 92, wherein the survey questions and responses are stored in a location remote from the computing device.

99. The system of claim 91, wherein the selection rate of each survey response is calculated by dividing the number of times the survey response was selected by the number of times the survey response was presented.

100. The system of claim 91, wherein the initial and adjusted selection rates for each survey response are determined in substantially real-time as the survey response information is stored.

101. The system of claim 91, wherein the adjusted selection rate is calculated using an adder for each survey response.

102. The system of claim 101, wherein the adder for each survey response is calculated by dividing the initial selection rate of each response by the total response rate for all responses other than the fallback response and multiplying the result by the reallocated value.

103. The system of claim 91, wherein the reallocated value is the number of fallback responses to be reallocated.

104. The system of claim 91, wherein an inclusion value is used to select the survey question.

105. The system of claim 104, wherein the inclusion value is based on conditional branching logic associated with each survey question.

106. The system of claim 104, wherein the inclusion value is based on a response variance associated with each survey question.

107. The system of claim 104, wherein the inclusion value for each survey question is a response variance.

108. The system of claim 104, wherein the inclusion value is based on a global inclusion value multiplier.

109. The system of claim 104, wherein the inclusion value is based on conditional branching logic, response variance, and a global inclusion value multiplier.

110-127. (canceled)

128. A machine readable medium having machine program logic recorded thereon for:
storing survey questions, survey responses, and survey response information;
selecting a survey question from a list of survey questions;
determining initial selection rates of survey responses corresponding to the selected survey question using the survey response information, wherein one survey response is a fallback response, and wherein the fallback response indicates that none of the other responses are appropriate;
determining a reallocated value of the fallback responses that would have been different had previously hidden responses been presented to previous survey participants, wherein at least one of the fallback responses is determined to have been the same had the previously hidden responses been presented to the previous survey participants;
determining an adjusted selection rate for each response based on the initial selection rate and the reallocated value;
selecting at least one survey response for the selected survey question based on the adjusted response selection rate for each response; and
providing the selected survey question and at least one response to a survey participant.

129. The machine readable medium of claim 128, wherein the selected survey question and at least one survey response are provided to the survey participant via a computing device.

130. The machine readable medium of claim 129, wherein the computing device is a personal computing device.

131. The machine readable medium of claim 129, wherein the computing device is an exit kiosk.

132. The machine readable medium of claim 129, wherein the computing device is a point-of-sale terminal.

133. The machine readable medium of claim 129, wherein the computing device is an interactive voice response system.

134. The machine readable medium of claim 129, wherein the survey questions and responses are stored in a location local to the computing device.

135. The machine readable medium of claim 129, wherein the survey questions and responses are stored in a location remote from the computing device.

136. The machine readable medium of claim 128, wherein the selection rate of each survey response is calculated by dividing the number of times the survey response was selected by the number of times the survey response was presented.

137. The machine readable medium of claim 128, wherein the initial and adjusted selection rates for each survey response are determined in substantially real-time as the survey response information is stored.

138. The machine readable medium of claim 19, wherein the adjusted selection rate is calculated using an adder for each survey response.

139. The machine readable medium of claim 138, wherein the adder for each survey response is calculated by dividing the initial selection rate of each response by the total response rate for all responses other than the fallback response and multiplying the result by the reallocated value.

140. The machine readable medium of claim 128, wherein the reallocated value is the number of fallback responses to be reallocated.

141. The machine readable medium of claim 128, wherein an inclusion value is used to select the survey question.

142. The machine readable medium of claim 141, wherein the inclusion value is based on conditional branching logic associated with each survey question.

143. The machine readable medium of claim 141, wherein the inclusion value is based on a response variance associated with each survey question.

144. The machine readable medium of claim 141, wherein the inclusion value for each survey question is a response variance.

145. The machine readable medium of claim 141, wherein the inclusion value is based on a global inclusion value multiplier.

146. The machine readable medium of claim 141, wherein the inclusion value is based on conditional branching logic, response variance, and a global inclusion value multiplier.
